(19) United States
(12) Patent Application Publication
(10) Pub. No.: US 2009/0291694 A1
(43) Pub. Date: Nov. 26, 2009

(54) Mobile station position locating system

(75) Inventors: Yoshiki Yano, Aichi-ken (JP); Takuya Nagai, Nagoya-shi (JP)

Correspondence Address: DAY PITNEY LLP, 7 TIMES SQUARE, NEW YORK, NY, 10036-7311, US

(73) Assignee: Brother Kogyo Kabushiki Kaisha

(21) Appl. No.: 12/387,249

(22) Filed: Apr. 30, 2009

(30) Foreign Application Priority Data
May 20, 2008 (JP) 2008-132551

(51) Int. Cl. H04W 4/02

(52) U.S. Cl. 455/456.5

(57) ABSTRACT

A radio wave transmitted from a mobile station 10 is received in each base station 12, and, based on the received power measured by a received power measuring portion 38 of the base station, a distance ratio calculating portion 54 of a position locating server 14 calculates the difference in the received power between the paired base stations. Based on the difference in the received power, the distance ratio is calculated between the distance from one base station to the mobile station and the distance from the other base station to the mobile station. A locus creating portion 56 of the position locating server 14 creates a locus which is a sequence of points showing positions where the calculated distance ratio is realized. The position calculating portion 58 calculates an intersection of the loci for a plurality of base station pairs, thereby calculating a candidate for the mobile station.

This application is based on Japanese Patent Application No. 2008-132551 filed on May 20, 2008, and content thereof is incorporated by reference.

### FIELD OF THE INVENTION

The present invention relates to a mobile station position locating system in which a plurality of base stations receive a radio wave transmitted from a mobile station and which estimates a position of the mobile station based on the reception result, i.e., the received power. Especially, the present invention relates to a technology enabling an accurate position locating even when a change occurs in a transmitted power from the mobile station due to battery exhaustion, etc.

### DESCRIPTION OF THE RELATED ART

A method has been suggested, in which a radio wave transmitted (sent) from a mobile station is received by a plurality of base stations, and the position of the mobile station is estimated based on the received power at each of the plurality of base stations. In this method, for example, received power is measured as an RSSI value and the distance between the base station of which received power is measured, and the mobile station which is the radio wave source is calculated, based on a predetermined relation. The predetermined relation is a relation between the received power, and a distance between the mobile station which transmits a radio wave, and the base station which receives a radio wave, previously obtained by experiment or simulation. The position of the mobile station is estimated based on the calculated distance between the plurality of base stations and the mobile station.

Specifically, the relation between the power of the received radio wave and the distance previously obtained experimentally or by simulation, etc., is applied to the received radio wave power determined as an RSSI value etc., to thereby calculate the distance between the mobile station which is the radio wave source, and the base station which is the radio-wave-receiving station. This calculation is performed for three or more base stations. Based on information about the known position of each base station and information about the calculated distance between each base station and the mobile station, the position of the mobile station is calculated that receives the radio wave based on the long-interval median value of the reception level (electric field strength) at the mobile station.

Incidentally, considering its mobility and the like, a mobile station may be driven with a rechargeable battery or a like battery. When the mobile station transmits a radio wave and the base station receives the radio wave, lowering of remaining power of the battery driving the mobile station may decrease the transmitted radio wave power from the mobile station (output).

In such a case, a relation between the actual received power (received strength) and the distance between the mobile station and the base station differs from the relation previously obtained by experiment or simulation based on, for example, a rated transmitted power. Accordingly, in calculation of the distance between the mobile station and the base station using the received power based on the previously obtained relation, an error may occur in the calculated distance. This results in a problem that position locating of the mobile station using such a distance does not provide accurate position of the mobile station.

FIG. 11 shows a relation between a value of the received power when a radio wave transmitted at a fixed power is received, and a distance between the radio wave source and the point where the radio wave is received. For example, supposing a case where an amount of the remaining power of a battery is sufficient to allow a radio wave to be transmitted from a mobile station at a fixed output (power), the relation represented by the curve Rnormal in FIG. 11 has been obtained. Based on such relation, when the received power Vr is Vr=Vrnormal, the distance between the base station that receives the radio wave and the mobile station that is the radio wave source is estimated to be Dnormal.

However, when the remaining power of the battery of the mobile station is low. which decreases the output of the radio wave transmitted from the mobile station, the relation between the received power and the distance is different from the previously calculated relation Rnormal. For example, the relation will be as represented by a curve Rlow placed lower than the curve Rnormal by A in FIG. 11, i.e., placed in a side of a lower received power. When the distance between the mobile station and the base station is Dnormal, the received power measured at the base station is Vrlow, which is smaller than Vrnormal. On the other hand, when the received power measured at the base station is Vrlow, the distance between the mobile station and the base station should be estimated to be Dnormal. However, based on the previously obtained relation, i.e., the curve Rnormal, the distance between the mobile station and the base station will be estimated to be Dlow.

As above, calculation of the distance between the mobile station and the base station based on the relation between the received radio wave power and the distance is obtained on the assumption that the radio wave be transmitted at a predetermined or fixed output from the radio wave source mobile station. Accordingly, there is a problem that an accurate distance cannot be always calculated, depending on the condition of the mobile station.

### SUMMARY OF THE INVENTION

The present invention was accomplished in view of the above background, and relates to a mobile station position locating system, in which a plurality of base stations receive a radio wave transmitted from a mobile station, and which estimates the position of the mobile station, based on a value related to the received power of the radio wave received by each base station and the position of the base station. The present invention is aimed to provide a mobile station position locating system, wherein the position of the mobile station is calculated (position located) based on the result of predetermined calculation of the received radio wave power at two base stations, thereby enabling position locating of the mobile station without using the previously obtained relation between the received power and the distance between the mobile station and the base station.

For achieving the above object, a first aspect of the present invention relates to a mobile station position locating system in which a plurality of base stations receive a radio wave transmitted from a mobile station, and which estimates a position of the mobile station based on a received power of the radio wave received by each base station and a position of the base station, wherein (a) the mobile station includes a transmitting portion that transmits the radio wave having a predetermined frequency, and the base stations each includes a receiving portion that receives the radio wave transmitted by the mobile station, and (b) a received power measuring portion that measures a received power of the radio wave received by the receiving portion.

The mobile station position locating system further comprises (c) a distance ratio calculating portion that calculates, based on a result of predetermined calculation of the received power measured by the received power measuring portion of each of the base stations constituting a base station pair which is a pair of the base stations, a distance ratio for every base station pair between the distance from one of the base stations constituting the base station pair to the mobile station and the distance from the other of the base stations constituting the base station pair to the mobile station, (d) a solution set calculating portion that calculates for every base station pair a set of solutions realizing the distance ratios calculated by the distance ratio calculating portion, and (e) a position calculating portion that determines a production set of a plurality of solution sets calculated by the solution set calculating portion to calculate, a solution belonging to the production set of the solution sets, as a mobile station existing position.

Preferably, in a second aspect of the present invention, the mobile station position locating system further comprises, when the position calculating portion calculates a plurality of solutions belonging to the production set of the solution sets, a position candidate selecting portion that selects the mobile station existing position, from candidates for the mobile station existing position corresponding to the plurality of solutions calculated by the position calculating portion, based on a position information of the mobile station calculated by a method different from a method used in the position calculating portion.

Preferably, in a third aspect of the present invention, the position candidate selecting portion selects, as the position of the mobile station, one of the positions calculated by the position calculating portion as the candidates for the mobile station existing position based on the information about a movable region of the mobile station.

Preferably, in a fourth aspect of the present invention, the position candidate selecting portion selects, as the position of the mobile station, one of the positions calculated by the position calculating portion as the candidates for the mobile station existing position based on an information about a movement history of the mobile station.

Preferably, in a fifth aspect of the present invention, the position calculating portion selects, as a reference base station, a base station with the highest received power measured by the received power measuring portion, to select the base station pairs as a combination of the reference base station and other base station.

Preferably, in a sixth aspect of the present invention, mobile station position locating system further comprises an error rate calculating portion calculating an error rate which is an error occurring degree in the radio wave received by each of the base stations transmitted from the mobile station, and wherein the position calculating portion selects, as the reference base station, the base station with the smallest error rate calculated by the error rate calculating portion, to select the base station pair as a combination of the reference base station and the other base station.

Preferably, in a seventh aspect of the present invention, the position calculating portion selects, as the reference base station, the base station with the highest resolution in the received power measuring portion, to select the base station pairs as a combination of the reference base station and the other base station.

According to the first aspect of the present invention, the distance ratio calculating portion calculates the distance ratio for every base station pair between the distance from one of the base stations constituting the base station pair to the mobile station and the distance from the other of the base stations constituting the base station pair to the mobile station. The calculation is based on the result of predetermined calculation of the received power measured by the received power measuring portion of each of the base stations constituting the base station pair which is the pair of the base stations. The solution set calculating portion calculates for every base station pair the set of solutions realizing the distance ratios calculated by the distance ratio calculating portion. The position calculating portion determines the production set of the plurality of solution sets calculated by the solution set calculating portion to calculate, a solution belonging to the production set of the solution sets, as the mobile station existing position.

Therefore, position of the mobile station can be located without using the relation between the received power and the distance between the mobile station and the base station obtained under a predetermined or fixed transmitted power from the mobile station. That is, because the position locating is not affected by the transmitted power, the position locating accuracy can be maintained even when the mobile station is low in the remaining power of the battery, and the transmitted power is increased.

According to the second aspect of the present invention, the mobile station position locating system further comprises the a position candidate selecting portion that selects the mobile station existing position, from candidates for the mobile station existing position corresponding to the plurality of solutions calculated by the position calculating portion, when the position calculating portion calculates a plurality of solutions belonging to the production set of the solution sets. The selection is base on the position information of the mobile station calculated by a method different from a method used in the position calculating portion.

Therefore, the position of the mobile station can be located without using the relation between the received power, and the distance between the mobile station and the base station obtained under the predetermined or fixed transmitted power from the mobile station. Accordingly, even upon absence of sufficient number of base stations, position locating can be performed without being affected by the transmitted power from the mobile station.

According to the third aspect of the present invention, the position candidate selecting portion selects, as the position of the mobile station, one of the positions calculated by the position calculating portion as the candidates for the mobile station existing position based on the information about the movable region of the mobile station. Therefore, the suitable position can be selected as the mobile station position.

According to the fourth aspect of the present invention, the position candidate selecting portion selects, as the position of the mobile station, one of the positions calculated by the position calculating portion as the candidates for the mobile station existing position based on an information about a movement history of the mobile station. Therefore, based on the movement history of the mobile station, the suitable position can be selected as the mobile station position.

According to the fifth aspect of the present invention, the position calculating portion selects, as a reference base station, the base station with the highest received power measured by the received power measuring portion, to select the base station pairs as the combination of the reference base station and other base station.

Therefore, it is possible to calculate the result of predetermined calculation of the received power at the base station pair that includes the base station, measuring the received power more accurately, that is measuring the received power to a higher value. As a result, the accuracy of the received power difference in each base station pair can be increased, which increases the accuracy of the position locating as a whole.

According to the sixth aspect of the present invention, the mobile station position locating system further comprises the error rate calculating portion calculating the error rate which is the error occurring degree in the radio wave received by each of the base stations transmitted from the mobile station, and wherein the position calculating portion selects, as the reference base station. The base station with the smallest error rate calculated by the error rate calculating portion, to select the base station pair as a combination of the reference base station and the other base station.

Accordingly, it is possible to calculate the result of predetermined calculation of the received power at the base station pair that includes the base station satisfactorily receives the radio wave from the mobile station with the small error rate, i.e., not suffering from interference externally. As a result, the accuracy of the received power difference in each base station pair can be increased, which resultantly increases the accuracy of the position locating as a whole.

According to the seventh aspect of the present invention, the position calculating portion selects, as the reference base station, the base station with the highest resolution in the received power measuring portion, to select the base station pairs as a combination of the reference base station and the other base station. Accordingly, it is possible to calculate the result of predetermined calculation of the received power at the base station pair that includes the base station where the received power is measured accurately, with the resolution preset at high level, or in the high sensitivity. As a result, the accuracy of the received power difference in each base station pair can be increased, which resultantly increases the accuracy of the position locating as a whole.

Preferably, the result of predetermined calculation is the ratio of the received radio wave power between the base stations constituting the base station pair, represented in antilogarithm. In such a case, the distance ratio calculating portion can calculate, based on the calculated result, the distance ratio between the distance from one of the base stations constituting the base station pair to the mobile station, and the distance from the other of the base stations constituting the base station pair to the mobile station.

Preferably, the received power is the received power represented in logarithm, and the result of predetermined calculation is the difference in the received radio wave power between the base stations constituting the base station pair, represented in logarithm. In this way, the received power represented in logarithm, which is widely used as an indicator for the received radio wave power, is measured in the received power measuring portion. In the distance ratio calculating portion, using the calculation result, i.e., the difference in the received power represented in logarithm between one and the other of the base stations constituting the base station pair, the distance to the mobile station is calculated.

In particular, the difference in the received power represented in logarithm between one and the other of the base stations constituting the base station pair is not affected by a change in the transmitted radio wave power from the mobile station. Accordingly, even upon change of the transmitted power from the mobile station, such as exhaustion of the battery of the mobile station, the distance ratio can be accurately calculated, which resultantly can accurately calculate the position of the mobile station.

### BRIEF DESCRIPTION OF THE DRAWINGS

FIG. 1 is an explanatory view explaining an outline of the mobile station position locating system of the present invention;

FIG. 2 is a block diagram explaining a structure and a control function of a mobile station included in the mobile station position locating system of the present invention;

FIG. 3 is a block diagram explaining a structure and a control function of a base station included in the mobile station position locating system of the present invention;

FIG. 4 is a block diagram explaining a structure and a control function of a position locating server included in the mobile station position locating system of the present invention;

FIG. 5 is an explanatory view explaining a locus of existence of a mobile station calculated based on the ratio of distances from the two base stations constituting a base station pair to the mobile station;

FIG. 6 is an explanatory view explaining calculation of the position of the mobile station from an intersection of loci corresponding to three base station pairs;

FIG. 7 is an explanatory view explaining calculation of a plurality of position candidates of the mobile station from a plurality of intersections of loci corresponding to three base station pairs;

FIG. 8 is an explanatory view explaining comparison between position candidates of the mobile station and the movement-allowing region, made by a region information comparing portion;

FIG. 9 is an explanatory view explaining comparison between position candidates of the mobile station and an estimated current position of the mobile station, made by a history information comparing portion;

FIG. 10 is a flowchart explaining an outline of the control operation of the mobile station position locating system of the present invention; and

FIG. 11 is an explanatory view explaining a relation between the distance from a radio wave source and the magnitude of the received power at the position at such a distance.

### BEST MODE FOR CARRYING OUT THE INVENTION

Hereinafter, an embodiment of the present invention is described in detail with reference to the drawings.

### First Embodiment

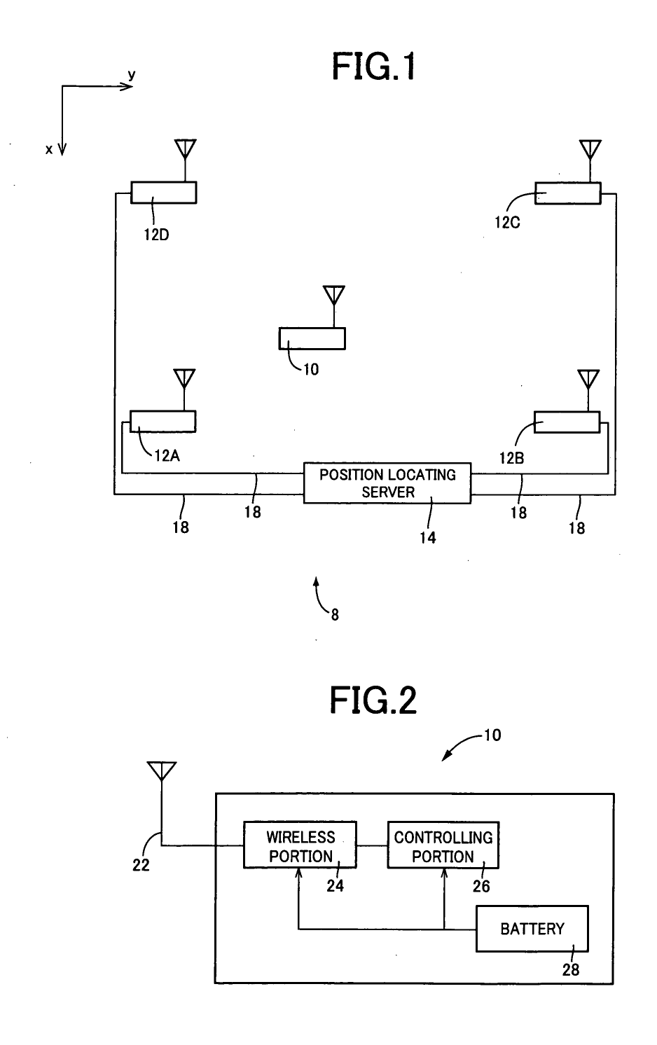

FIG. 1 shows one example of the structure of the mobile station position locating system 8 of the present invention. As shown in FIG. 1, the mobile station position locating system 8 comprises a mobile station 10, four base stations 12, and a position locating server 14. The four base stations 12 include a first base station 12A to a fourth base station 12D, each fixed to a known position, having a function to wirelessly communicate with the mobile station 10 (hereinafter, when the first base station 12A to the fourth base station 12D are not distinguished, they are referred to as base stations 12). The position locating server 14 comprises a so-called computer provided with CPU, RAM, ROM, input/output interfaces, etc., for example. The number of mobile stations 10 is not limited insofar as it is one or more. The base stations 12 are each connected to the position locating server 14 via a telecommunication cable 18, such as a LAN cable to be mutually intercommunicated.

In addition, a coordinate system as shown in FIG. 1 is set in a movable region (in FIG. 1, plane) of the mobile station 10, and the positions of the mobile station 10 and the base stations 12 can be expressed or represented by coordinates in such a coordinate system.

FIG. 2 is a functional block diagram for explaining the principal part of the function of the mobile station 10. Among the components, a wireless portion 24 which performs transmission/reception of a radio wave using an antenna 22 according to the contents of the control by a controlling portion 26 mentioned below. For example, when receiving a radio wave including the below-mentioned command to control the operation of the mobile station 10 transmitted from the base station 12 or receives a command to transmit a radio wave for position locating, the wireless portion 24 transmits a radio wave at a predetermined radio wave output or with predetermined radio wave characteristics. That is, the wireless portion 24 has a transmitting function and a receiving function.

The transmitting function is realized by an oscillator generating a carrier wave of a predetermined frequency, a modulator modulating the carrier wave based on a signal transmitted by radio wave, a transmission amplifier amplifying the modulated carrier wave to a predetermined output, etc. The receiving function is realized by a reception amplifier amplifying the wave received by the antenna 22, a filter selectively extracting a predetermined frequency component from the received wave, and a demodulator performing digital demodulation or demodulation by a wave detector, etc. A battery 28, constituted by a well known battery, etc., supplies power to the wireless portion 24 and the controlling portion 26.

The controlling portion 26 controls the operation of the mobile station 10, and is constituted by a so-called microcomputer provided with CPU, RAM, ROM, input/output interfaces, etc., for example. CPU performs signal processing according to the program previously stored in ROM using the temporary storage function of RAM, to thereby perform processing, such as switching between transmission and reception of the radio wave from the mobile station 10, modulation and demodulation of a transmitted or received radio wave, generation of a signal included in the transmitted radio wave, and the like. Specifically, for example, CPU analyzes the radio wave received by the wireless portion 24, extracts a command concerning the operation of the mobile station 10, and transmits the radio wave from the wireless portion 24 in response to the command.

The antenna 22 is used when the above-mentioned wireless portion 24 transmits or receives a radio wave, in a suitable frequency of the radio wave for transmission or reception by the wireless portion 24. When the distance from the mobile station, i.e., from the antenna 22 is the same, for reception of the radio wave at the same strength, an antenna which is at least non-directional with the radio wave propagation direction is preferably used as the antenna 22.

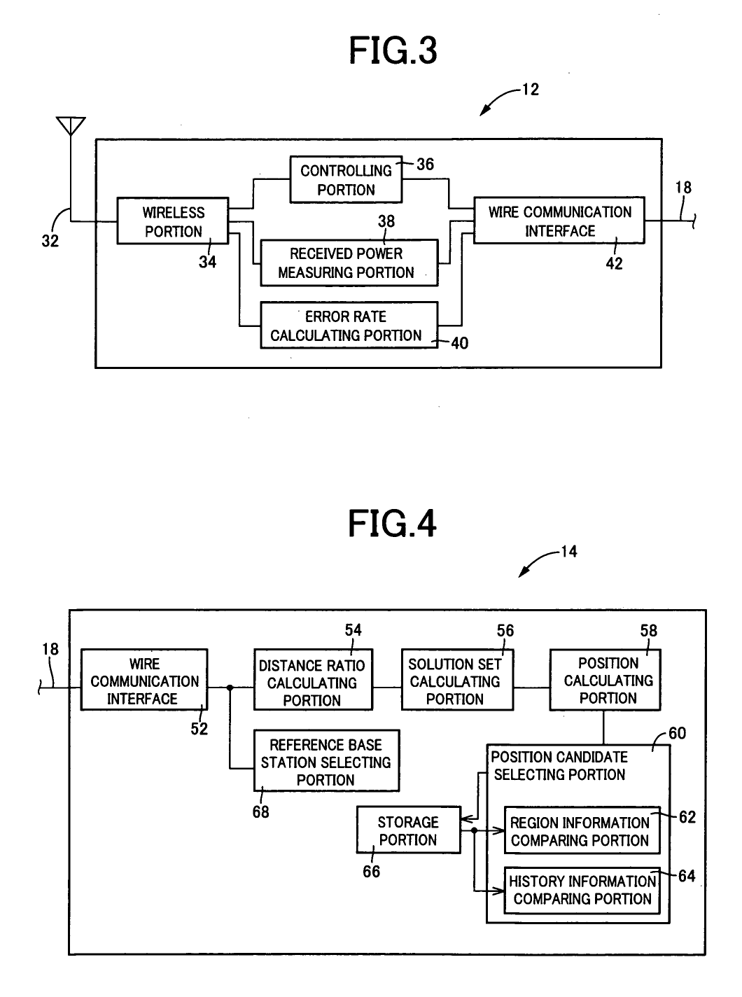

FIG. 3 is a functional block diagram for explaining the principal part of the function of a base station 12. The base station 12 has an antenna 32 for transmitting/receiving a radio wave, a wireless portion 34, a controlling portion 36, a received power measuring portion 38, an error rate calculating portion 40, a wire communication interface 42, etc. The base station 12 is constituted by a so-called computer provided with CPU, RAM, ROM, input/output interfaces, etc., for example. CPU performs signal processing according to the program previously stored in ROM using the temporary storage function of RAM, to thereby realize functions of the controlling portion 36, the received power measuring portion 38, the error rate calculating portion 40, etc. The wireless portion 34 has the same function as with the wireless portion 24 of the above-mentioned mobile station 10, i.e., the function of transmitting/receiving a radio wave using the antenna 32.

The controlling portion 36 controls the operation of the base station 12, that is performs processing, such as switching between transmission and reception of a radio wave of a base station 12, modulation and demodulation of the transmitted or received radio wave, etc. Specifically, the controlling portion 36 switches between transmission and reception at the wireless portion 34, or control the operation of the below-mentioned received power measuring portion 38 and error rate calculating portion 40. Further, based on a command from the below-mentioned server 14, it wirelessly transmits a command concerning the operation of the mobile station 10.

The received power measuring portion 38 measures the received power of the radio wave received in the wireless portion 34 (received wave). Specifically, for example, an index value called RSSI (Receive Signal Strength Indicator), which is a numerical expression of a radio wave reception strength peculiar to a hardware, is first measured, and the measured RSSI is converted based on the specification of the hardware, to obtain the received power. The RSSI is a numerical value expressed in 256 grades from 0 to 255, calculated based on the magnitude of the voltage at the electricity point in the antenna upon receiving of the radio wave, for example.

The wire communication interface 42 is connected with other base stations 12 or the position locating server 14 through a telecommunication cable 18, such as a LAN cable, for example, in an information exchangeable manner. In the present embodiment, as explained in FIG. 1 above, each of the base stations is connected with the position locating server 14 in an intercommunicable manner. Specifically, information about the power of the received wave measured by the received power measuring portion 38 and information about the error rate calculated by the error rate calculating portion 40 are transmitted to the position locating server 14 through the telecommunication cable 18. Further, a command concerning the operation of the base stations 12 and the like transmitted from the position locating server 14 are received by the received power measuring portion 38.

The error rate calculating portion 40 is used in the below-mentioned other embodiment, and the explanation thereof is omitted. That is, the error rate calculating portion 40 is not required in the first embodiment.

FIG. 4 is a functional block diagram for explaining the principal part of the function of the position locating server 14. The position locating server 14 is constituted by a wire communication interface 52, a distance ratio calculating portion 54, a solution set calculating portion 56, a position calculating portion 58, a position candidate selecting portion 60, a region information comparing portion 62, a history information comparing portion 64, a storage portion 66, a reference base station selecting portion 68, etc. Among these, the wire communication interface 52 is connected with each of the base stations 12 through the telecommunication cable 18 in the information exchangeable manner. Specifically, for example, the wire communication interface 52 receives information about the power of the received wave and information about the error rate from a base station 12. Further, the wire communication interface 52 transmits command concerning the operation of a base station 12, a command concerning the operation of the mobile station 10, and the like to the base station 12. This is because the mobile station 10 does not have a wire communication interface and the position locating server 14 does not have a wireless portion, and thus commands from the position locating server 14 to the mobile station 10 are transmitted through the wireless portion 34 of one of the base stations 12.

The distance ratio calculating portion 54 first acquires the received power measured in the received power measuring portion 38 of each base station 12 at the time when the each base station 12 receives the radio wave transmitted by the wireless portion 24 of the mobile station 10 at a predetermined output. The value of the received power obtained as above is the power expressed in decibels of which unit is expressed by dBm.

Subsequently, the distance ratio calculating portion 54 creates a base station pair, which is a combination of two base stations, from the plurality of base stations 12. Specifically, among the plurality of base stations 12, a reference base station selected by the below-mentioned reference base station selecting portion 68 and a base station other than the reference base station are paired to give a base station pair. For example, as shown in FIG. 1, among four base stations from the first base station 12A to the fourth base station 12D, if the first base station 12A is selected by the reference base station selecting portion 68 as a reference base station, the selected base station and a base station other than the selected base station are paired. That is, three base station pairs, the first base station 12A and the second base station 12B, the first base station 12A and the third base station 12C, the first base station 12A and the fourth base station 12D, are created.

The distance ratio calculating portion 54 performs predetermined calculation about the received power at the two base stations constituting each of the created base station pairs. The result of predetermined calculation obtained by such predetermined calculation is the difference in received power expressed in decibels, for example. Specifically, for example, the difference is calculated by subtracting, from the value of the power of the radio wave transmitted from the mobile station and received by the reference base station of the two base stations constituting a base station pair, the power of the radio wave transmitted from the mobile station and received by the base station which is not the reference base station.

The following is an explanation of the case where three base station pairs, the first base station 12A and the second base station 12B, the first base station 12A and the third base station 12C, the first base station 12A and the fourth base station 12D, are created, as mentioned above. The difference ΔVr₁₂ (dBm) between the received power Vr₁ (dBm) of the first base station 12A and the received power Vr₂ (dBm) of the second base station 12B is calculated as ΔVr₁₂=Vr₁−Vr₂. The difference ΔVr₁₃ (dBm) between the received power Vr₁ (dBm) of the first base station 12A and the received power Vr3 (dBm) of the third base station 12C is calculated as ΔVr₁₃=Vr₁−Vr3. The difference ΔVr₁₄ (dBm) between the received power Vr₁ (dBm) of the first base station 12A and the received power Vr₄ (dBm) of the fourth base station 12D is calculated as ΔVr₁₄=Vr₁−Vr₄.

Further, the distance ratio calculating portion 54 calculates, based on the calculated received power difference in each base station pair, the ratio of distances from the two base stations constituting the base station pair to the mobile station that transmitted the radio wave. The calculation of the ratio of distances is performed as follows. First, in the base station received the radio wave from the mobile station, the relation between the received power Vr (dBm), and the distance D (m) between the mobile station and the base station is given by the following Equation (1).

Vr=−20 log(4πDf/c)+GTA+GRA+Pt (1)

Here, GTA (dBi) expresses a transmitting antenna gain, i.e., a gain of the antenna 22 of the mobile station 10 transmitting the radio wave, and GRA (dBi) is a receiving antenna gain, i.e., a gain of the antenna 32 of a base station 12 receiving the radio wave. Pt (dBm) is a transmitted power at the mobile station 10, f (Hz) is the frequency of the transmitted radio wave, and c (m/s) is the speed of light, i.e., the radio wave propagation velocity.

Using this Equation (1), for example, the difference A Vr₁₂ between the received power Vr₁ of the first base station 12A and the received power Vr₂ of the second base station 12B is expressed by the following Equation (2).

$$\begin{matrix}Δ {Vr}_{12} = {Vr}_{1} \cdot {Vr}_{2} \\ = - 20 log ( 4 π {D}_{1} f \text{/} c ) + GTA + GRA + Pt - \\ ( - 20 log ( 4 π {D}_{2} f \text{/} c ) + GTA + GRA + Pt ) \\ = - 20 log ( 4 π {D}_{1} f \text{/} c ) + 20 log ( 4 π {D}_{2} f \text{/} c ) \\ = 20 log ( {D}_{2} \text{/} {D}_{1} )\end{matrix} \qquad ( 2 )$$

Here, D₁ represents the distance between the first base station 12A and the base station 10, and D₂ represents the distance between the second base station 12B and the base station 10. Thus, the difference ΔVr₁₂ in the received power between the paired base stations does not involve the transmitted power Pt at the mobile station 10, not being affected by the transmitted power Pt.

Further, from the above Equation (2), following Equation (3) is obtained.

(D₂/D₁)=exp(ΔVr₁₂/20) (3)

In this way, the ratio of distances from the two base stations constituting a base station pair to the mobile station transmitting the radio wave can be calculated. The following is an explanation of the case where three base station pairs, the first base station 12A and the second base station 12B, the first base station 12A and the third base station 12C, the first base station 12A and the fourth base station 12D, are created, as mentioned above. Based on the difference ΔVr₁₂ between the received power Vr₁ of the first base station 12A and the received power Vr₂ of the second base station 12B, the ratio (distance ratio) (D₂/D₁) between the distance D₁ from the first base station 12A to the mobile station 10 and the distance D₂ from the second base station 12B to the mobile station 10 is calculated. Likewise, the ratio (distance ratio) (D₃/D₁) between the distance D₁ from the first base station 12A to the mobile station 10 and the distance D₃ from the third base station 12C to the mobile station 10 is calculated. The ratio (distance ratio) (D₄/D₁) between the distance D₁ from the first base station 12A to the mobile station 10 and the distance D4 from the fourth base station 12D to the mobile station 10 is calculated.

At this time, the mobile station 10 positionally exists, in a relation with the position of the first base station 12A and that of the second base station 12B, in any one point in a solution set S1 satisfying the condition that the distance ratio between the distance D₁ from the first base station 12A to the mobile station 10 and the distance D₂ from the second base station 12B to the mobile station 10 is (D₂/D₁). Likewise, the position of the mobile station 10 exists in any one point in a solution set S2 satisfying the condition that the ratio between the distance D₁ from the first base station 12A to the mobile station 10 and the distance D₃ from the third base station 12C to the mobile station 10 is (D₃/D₁), and also in any one point in a solution set S3 satisfying the condition that the ratio between the distance D₁ from the first base station 12A to the mobile station 10 and the distance D₄ from the fourth base station 12D to the mobile station 10 is (D₄/D₁). Accordingly, the position of a mobile station 10 is specified in any one point in a production set S of the solution sets S1, S2, and S3=S∩S2∩S3, which satisfies all of these conditions.

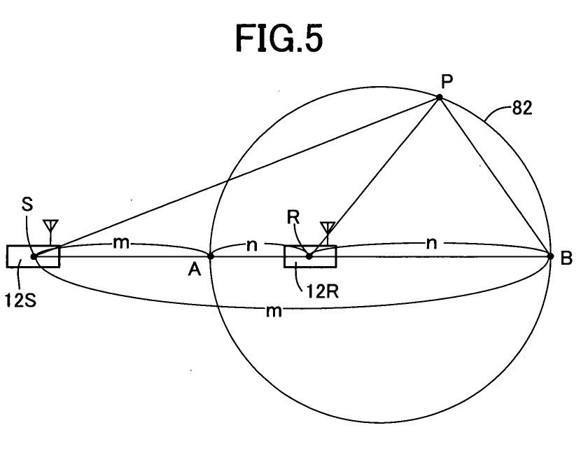

The solution set calculating portion 56 calculates solution sets S1 to S3, which are sets of solutions that satisfy the distance ratios for base station pairs, respectively, calculated by the distance ratio calculating portion 54, for respective base station pairs. Here, as shown in FIG. 5, the locus of the point P where the distance thereto from two points S and R on a plane is m:n (n≠1) forms, defining the point that internally divides the line segment SR as “A”, and the point that externally divides the line segment SR as B, a circle 82 of which diameter is a line segment AB, i.e., Apollonius circle. Accordingly, the solution set calculating portion 56 creates, based on the Apollonius circle, a locus that is a sequence of points showing a position of the mobile station, realizing the distance ratio for every base station pair calculated in the distance ratio calculating portion 54, i.e., the ratio of distances from the base stations that constitute a base station pair to the mobile station. This locus corresponds to the solution set. Hereinafter, a specific explanation is given about the case where a base station 12S exists in the point S and a base station 12R exists in the point R in FIG. 5. When the ratio between the distance from the base station 12S to the mobile station and the distance from the base station 12R to the mobile station (D_{S}/D_{R}) calculated by the distance ratio calculating portion is represented by D_{S}/D_{R}=m/n, the locus expressing the position of the mobile station 10, i.e., a solution set, is expressed by the circle 82 in FIG. 5.

Specifically, for example, with respect to the base station pair formed of the first mobile station 12A and the second mobile station 12B, when the value of the distance ratio (D₂/D₁) calculated by the distance ratio calculating portion 54 is expressed as “a”, the coordinate of the first mobile station 12A as (X1, Y1), the coordinate of the second mobile station 12B as (X₂, Y₂), and the coordinate of the mobile station 10 as (x, y), Equation (4) expressing the locus of the circle is obtained.

$$\begin{matrix}{D}_{2} / {D}_{1} = a ⇔ \frac{\sqrt{{( x - {X}_{1} )}^{2} + {( y - {Y}_{1} )}^{2}}}{\sqrt{{( x - {X}_{2} )}^{2} + {( y - {Y}_{2} )}^{2}}} \\ = a ⇔ {a}^{2} \{ {( x - X 1 )}^{2} + {( y - {Y}_{1} )}^{2} \} \\ = {( x - {X}_{2} )}^{2} + {( y - {Y}_{2} )}^{2} ⇔ {( x - \frac{{a}^{2} {X}_{1} - {X}_{2}}{{a}^{2} - 1} )}^{2} + \\ ( y - \frac{{a}^{2} {Y}_{1} - {Y}_{2}}{{a}^{2} - 1} ) \\ = {( \frac{a}{{a}^{2} - 1} )}^{2} \{ {( {X}_{1} - {X}_{2} )}^{2} + {( {Y}_{1} - {Y}_{2} )}^{2} \}\end{matrix} \qquad ( 4 )$$

When, for example, three base station pairs, the first base station 12A and the second base station 12B, the first base station 12A and the third base station 12C, and the first base station 12A and the fourth base station 12D, are created as mentioned above, loci expressed by Equations (5) and (6) are similarly calculated for base station pairs formed of the first base station 12A and the third base station 12C and of the first base station 12A and the fourth base station 12D, respectively.

$$\begin{matrix}{( x - \frac{{b}^{2} {X}_{1} - {X}_{3}}{{b}^{2} - 1} )}^{2} + {( y - \frac{{b}^{2} {Y}_{1} - {Y}_{3}}{{b}^{2} - 1} )}^{2} = {( \frac{b}{{b}^{2} - 1} )}^{2} \{ \begin{matrix}{( {X}_{1} - {X}_{3} )}^{2} + \\ {( {Y}_{1} - {Y}_{3} )}^{2}\end{matrix} \} & ( 5 ) \\ {( x - \frac{{c}^{2} {X}_{1} - {X}_{4}}{{c}^{2} - 1} )}^{2} + {( y - \frac{{c}^{2} {Y}_{1} - {Y}_{4}}{{c}^{2} - 1} )}^{2} = {( \frac{c}{{c}^{2} - 1} )}^{2} \{ \begin{matrix}{( {X}_{1} - {X}_{4} )}^{2} + \\ {( {Y}_{1} - {Y}_{4} )}^{2}\end{matrix} \} & ( 6 )\end{matrix}$$

In addition, in Equation (5), b is a value of the distance ratio (D₃/D₁) calculated by the distance ratio calculating portion 54 for the base station pair formed of the first mobile station 12A and the third mobile station 12C. In Equation (6), c is a value of the distance ratio (D₄/D₁) calculated by the distance ratio calculating portion 54 for the base station pair formed of the first mobile station 12A and the fourth mobile station 12D. The loci which are sets of solutions (x, y) satisfying Equations (4) to (6), respectively, correspond to solution sets S1 to S3, respectively.

The position calculating portion 58 calculates the production set S of the solution sets S1 to S3 calculated in the solution set calculating portion 56, to thereby calculate the position of the mobile station 10. In the present embodiment, since the solution sets are each the locus that provides the circle, an intersection of the loci corresponding to the plurality of solution sets S1 to S3 corresponds to the production set S.

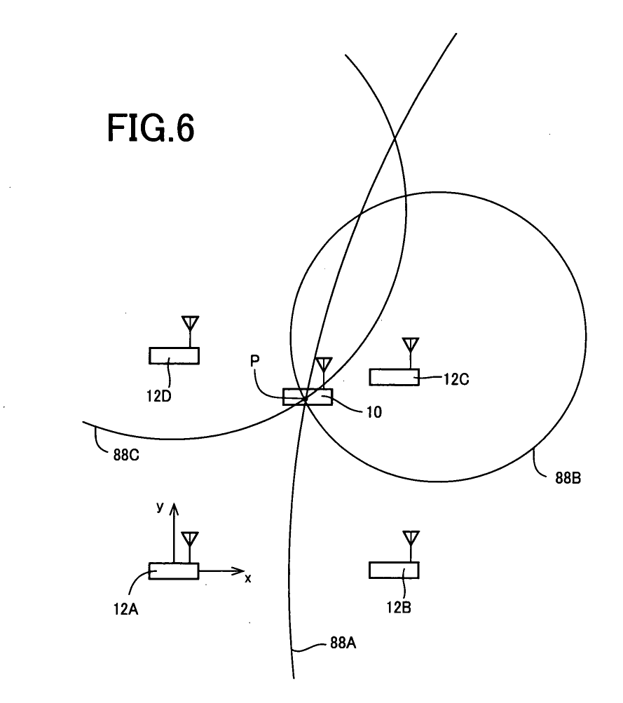

Specifically, a point that simultaneously satisfies the equations that expresses the plurality of loci respectively created by the solution set calculating portion 56 is calculated, to thereby calculate the position of the intersection at the position calculating portion 58. When, for example, three base station pairs, the first base station 12A and the second base station 12B, the first base station 12A and the third base station 12C, the first base station 12A and the fourth base station 12D, are created as mentioned above, a solution (x, y) that simultaneously satisfies Equations (4) to (6) corresponding to three loci 88A, 88B, and 88C (see FIG. 6), respectively, which correspond to these base station pairs respectively. The intersection P of the three loci is thereby calculated as the position of the mobile station 10. As shown in FIG. 6, when the position of the mobile station 10 is calculated as an intersection of loci, at least three loci are necessary or required, and accordingly, at least three base station pairs corresponding thereto are necessary. Moreover, such at least three base station pairs have to be formed of at least four base stations.

Incidentally, there are cases where only three base stations 12 exist only three base stations 12, among four or more base stations 12, can receive the radio wave from the mobile station 10; four base stations are located in the positions that constitute vertexes of a square, respectively; etc. In these cases, the distance ratio calculating portion 54 calculates the distance ratio only for two base station pairs. Because only two loci corresponding to the two base station pairs are calculated as solution sets, a plurality of intersections of the loci which are the production sets S calculated by the position calculating portion 58 may include a plurality of points. Accordingly, the position calculating portion 58, disenabling of specifying the position of the mobile station 10, calculates a plurality of position candidates i.e., candidates for position of the mobile station 10.

As mentioned above, the position calculating portion 58 may calculate position candidates of the mobile station 10 based on the intersections of the two loci created in the locus creating portion 56. That is, a plurality of intersections calculated as intersections of the loci are the positions that satisfy the distance ratios about a plurality of base station pairs, and one of them is the position of the mobile station 10. Specifically, a point that simultaneously satisfies the equations expressing two loci created respectively is calculated by the solution set calculating portion 56, to thereby calculate the position of the intersection.

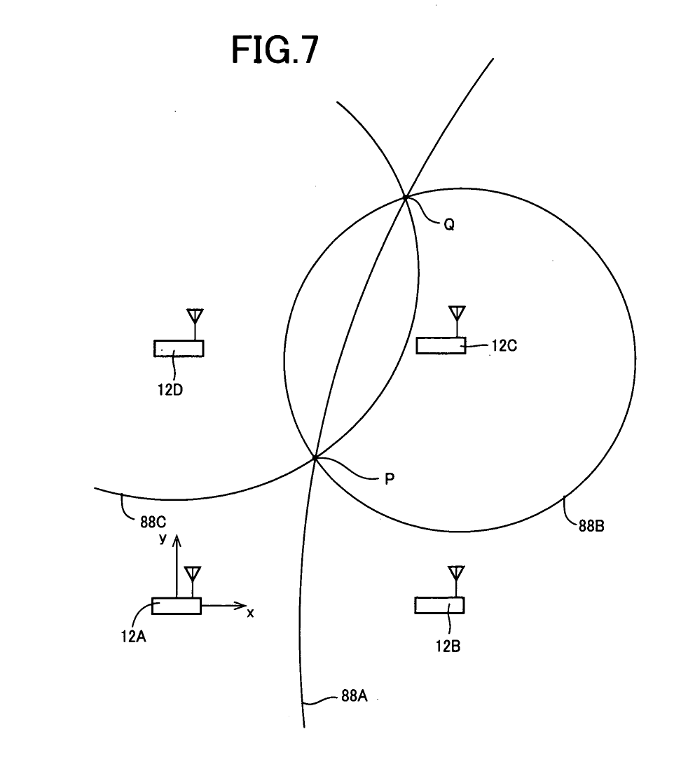

For example, as shown in FIG. 7, when the first base station 12A, the second base station 12B, the third base station 12C, and the fourth base station 12D are arranged to constitute square vertexes, the three loci 88A, 88B, and 88C shown in FIG. 7 intersect with one another at a point P and a point Q. Specifically, a solution (x, y) that simultaneously satisfies Equations (4) to (6) is calculated, which corresponds to the three loci 88A, 88B, and 88C respectively, that correspond to a base station pair formed of the first base station 12A and the second base station 12B, a base station pair formed of the first base station 12A and the third base station 12C, and a base station pair formed of the first base station 12A and the fourth base station 12D, respectively. As a result, two intersections P and Q of the two loci are calculated as the position candidates of the mobile station 10.

The position candidate selecting portion 60 selects one of the position candidates of the mobile station 10 calculated by the position calculating portion 58, as the position thereof. The position candidate selecting portion 60 includes at least either a region information comparing portion 62 or a history information comparing portions 64. The position candidate selecting portion 60 selects the position of the mobile station 10 based on either the region information given by the region information comparing portion 62 which is an information about the region where the mobile station 10 can exist, or the information about the movement history of the mobile station 10 given by the history information comparing portion 64.

The region information comparing portion 62 compares the information about the existing region of the mobile station 10 with the position candidates of the mobile station 10 calculated by the position calculating portion 58. That is, when the mobile station 10 is movable only in a limited region, such as a room divided by a wall, etc., the information about the movable region (region information) of the mobile station 10 is previously stored in, for example, the below-mentioned mobile station position storage portion 66, etc. The region information, read out from the mobile station position storage portion 66, is compared with the position candidates of the mobile station 10 calculated by the position calculating portion 58. Then, based on the region information, the position candidates of the mobile station 10 are examined whether they are inside or outside the movable region of the mobile station 10. The position candidates of the mobile station 10 that are judged to be outside movable region are excluded by the position candidate selecting portion 60.

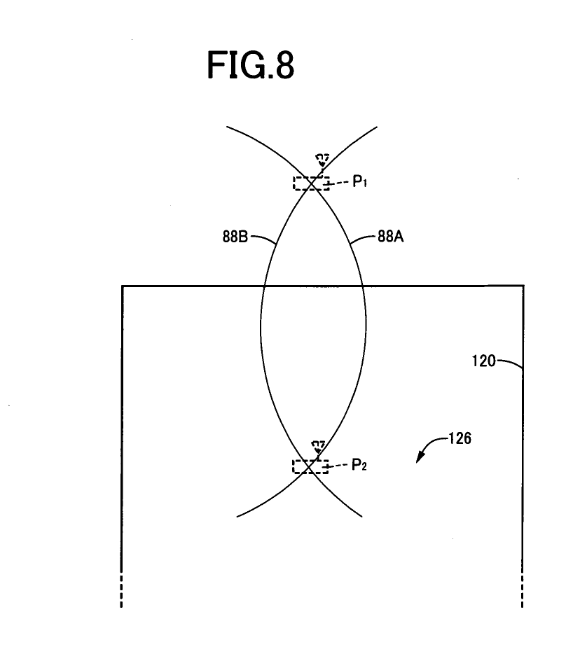

FIG. 8 is an explanatory view explaining the operation of the region information comparing portion 62 and the position candidate selecting portion 60. Two orbits 88A and 88B calculated from the distance ratio between two base station pairs are calculated by the position calculating portion 58, etc. As intersections thereof, two position candidates P1 and P2 of the mobile station 10 are obtained.

Meanwhile, supposing that the region information previously stored in the mobile station position storage portion 66, that is movable region of the mobile station 10, is a region 126 surrounded by a line 120. The region information comparing portion 62 compares the positions of candidates P1 and P2 for the position of the mobile station 10 with the region information, i.e., the position of the movement-allowing region 126. The candidate P2 is judged to be inside movable region of the mobile station 10, while the candidate P1 is judged not to be inside movable region of the mobile station 10. Based on this judgment, the position candidate selecting portion 60 excludes the candidate P1 from position candidates of the mobile station 10. As a result, the candidate P2 is considered to be the only candidate for the position of the mobile station 10, and thus the position candidate selecting portion 60 selects the position candidate P2 as the position of the mobile station 10.

In the first embodiment, position locating of the mobile station 10 by the mobile station position locating system 8 may be repeatedly performed at predetermined intervals. In this case, the mobile station position storage portion 66 of the position locating server 14 realized by a storage means of a computer or the like, stores information about the positions i.e., position information previously selected by the mobile station position candidate selecting portion 60 as the positions of the mobile station 10 and the time when the position was located (movement history information), for the predetermined number of times.

The history information comparing portion 64 predicts the current position of the mobile station 10 based on the movement history information stored in the mobile station position storage portion 66. The predicted current position of the mobile station 10 is compared with a plurality of position candidates of the mobile station calculated by the position calculating portion 58. As a result of the comparison, the position candidate selecting portion 60 selects the mobile station position candidate which is closest to the predicted position of the mobile station 10, as the current position of the mobile station 10.

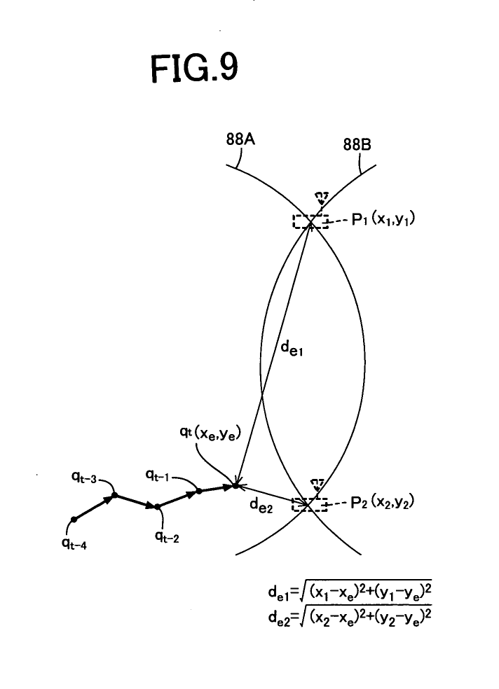

FIG. 9 is an explanatory view explaining the operation of the history information comparing portion 64 and the position candidate selecting portion 60 at that time. In FIG. 9, the two candidates for the mobile station position calculated by the position calculating portion 58 are a candidate P1 and a candidate P2. Meanwhile, a point qₜ₋₁, a point qₜ₋₂, a point qₜ₋₃, and a point qₜ₋₄ express the positions determined to be the position of the mobile station 10 in the first to fourth previous position locating processes, respectively. The history information comparing portion 64 predicts, based on the positions of the point qₜ₋₁, the point qₜ₋₂, the point qₜ₋₃, and the point qₜ₋₄, the predicted position qt (xₑ, yₑ) of the current mobile station 10.

The distance dₑ₁ from the predicted position qt of the mobile station 10 to the candidate P1, and the distance de₂ from the predicted position qt of the mobile station 10 to the candidate P2, are each calculated. The position candidate selecting portion 60, compares the calculated distance dₑ₁ and distance de₂, to select the mobile station position candidate where such a distance is smaller, as the actual position of the mobile station 10. That is, taking the example of FIG. 9, since the relation is dₑ₁>de₂, the mobile station position candidate P2 corresponding to the smaller distance de₂ is selected as the actual position of the mobile station 10.

Specifically, the history information comparing portion 64 predicts the predicted position qt (xₑ, yₑ) of the current mobile station as follows, for example. The traveling speed of the mobile station 10 in the current predicted position qt is expressed as vₜ, and the acceleration rate as at. Similarly, the traveling speed of the mobile station 10 at the position qₜ₋₁ in the first previous position locating is expressed as vₜ₋₁, and the acceleration rate as aₜ₋₁. The traveling speed of the mobile station 10 at the position qₜ₋₂ in the second previous position locating is expressed as Vₜ₋₂, and the acceleration rate as aₜ₋₂; the traveling speed of the mobile station 10 at the position qₜ₋₃ in the third previous position locating is expressed as vₜ₋₃, and the acceleration rate as aₜ₋₃; and the traveling speed of the mobile station 10 at the position qₜ₋₄ in the fourth previous position locating is expressed as vₜ₋₄, and the acceleration rate as aₜ₋₄.

Supposing that the current acceleration rate is the average of the traveling acceleration rates of the mobile station 10 in the previous two position locating processes, the relation can be expressed by the following Equation (7).

at=(aₜ₋₁+aₜ₋₂)/2 (7)

At this time, when position locating by the mobile station position locating system 8 is repeated in an extremely short period of time, the traveling acceleration rate at of the mobile station 10 in a certain position locating is expressed using the traveling speed vₜ of the mobile station 10 in such a position locating, and the traveling speed vₜ₋₁ of the mobile station 10 in the first previous position locating, as at=vₜ−vₜ₋₁. Further, the traveling speed vₜ of the mobile station 10 in a certain position locating is expressed using the position qt of the mobile station 10 in such a position locating, and the position qₜ₋₁ of the mobile station 10 in the first previous position locating, as vₜ=qt−qₜ₋₁. Accordingly, the Equation (7) can be sequentially rewritten as below.

vₜ−vₜ₋₁=((vₜ₋₁−vₜ₋₂)+(vₜ₋₂−vₜ₋₃))/2

(qt−qₜ₋₁)−(qt−qₜ₋₁)=(((qₜ₋₁−qₜ₋₂)+(qₜ₋₂−qₜ₋₃))+((qₜ₋₂−qₜ₋₃)+(qₜ₋₃−qₜ₋₄))/2.

The equation is arranged about qt as below.

qt=(5qₜ₋₁−3qₜ₋₂−qₜ₋₃+qₜ₋₄)/2

Thus, the predicted current position qt of the mobile station 10 is calculated.

When creating base station pairs in the distance ratio calculating portion 54, the reference base station selecting portion 68 selects the reference base station to be contained in all the base station pairs. When, for example, three base station pairs, the first base station 12A and the second base station 12B, the first base station 12A and the third base station 12C, the first base station 12A and the fourth base station 12D, are created as mentioned above, the first base station 12A is selected as the reference base station.

At this time, the received power Vr₁ of the first base station 12A, contained in all the Equations (4) to (6) for calculating the position of the mobile station 10, affects the calculated position of the mobile station 10. In this way, the received radio wave power in the reference base station greatly affects the result of position locating of the mobile station 10. Accordingly, as the reference base station, the base station of which received radio wave power can be accurately measured is preferably selected. Therefore, considering the received power of the radio wave from the mobile station 10 measured in the received power measuring portion 38 of each base station 12, the reference base station selecting portion 68 selects the base station with the highest power as the reference base station. This is because the base station with the higher received radio wave power locates in a position closer to the mobile station, and performs more accurate measurement of the received power, thus being suitable as the reference base station.

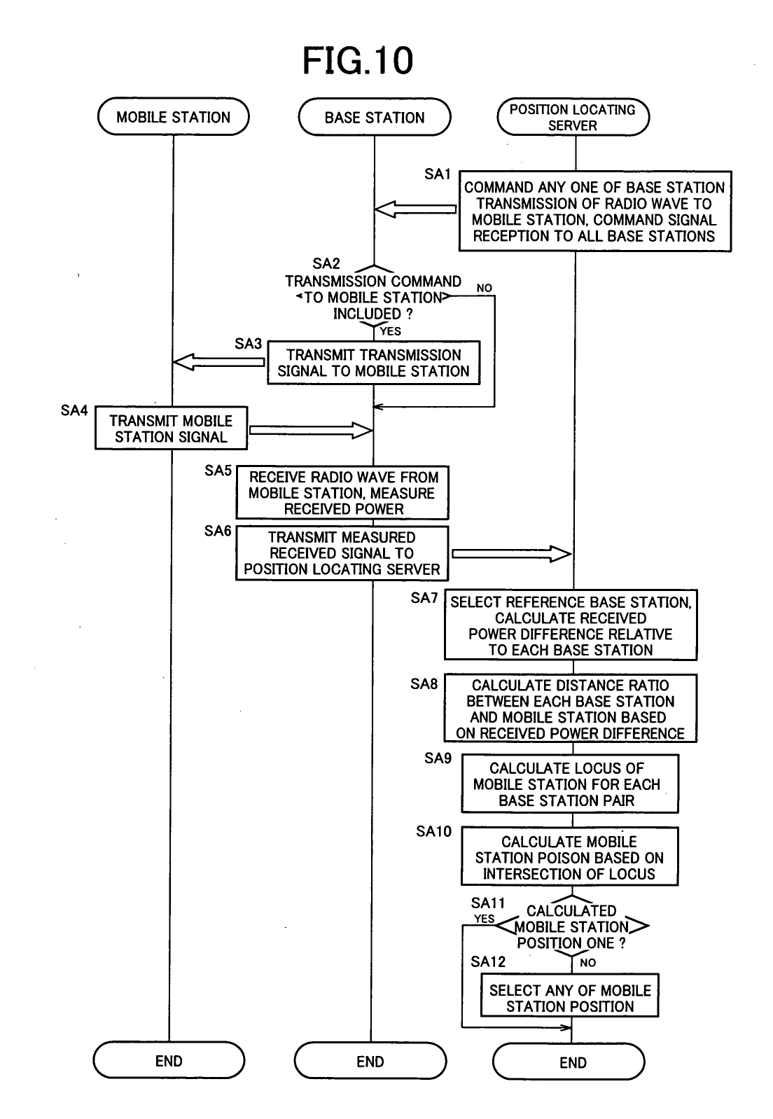

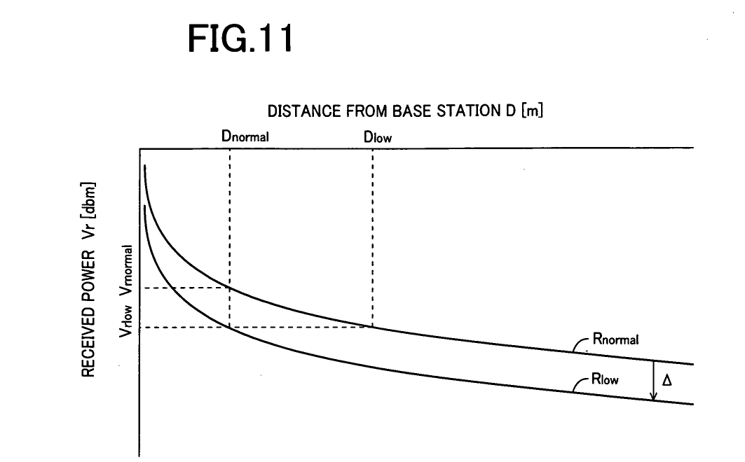

FIG. 10 is a flowchart explaining the outline of the control operation of the mobile station position locating system of the present invention, in which the control operations of the mobile station 10, the base station 12, and the position locating server 14 are shown. First, in a step SA1 (hereinafter, term “step” is omitted), when the operation for position locating of a mobile station 10 is started in the position locating server 14, a command to wirelessly transmit the radio-wave-transmitting command to the mobile station 10 is issued or outputted from the position locating server 14 to any one base station 12, for example, the first base station 12A At this time, any one base station 12 may be always the same base station 12, or the different base station 12 may be selected each time. Further, in SA1, all the base stations 12 are commanded to stand ready for receiving the radio wave from the mobile station 10. These commands are issued through the wire communication interface 52 of the position locating server 14, the telecommunication cable 18, the wire communication interface 42 of each base station, etc.

In SA2 corresponding to the controlling portion 36 of each base station 12, the command issued by the position locating server 14 in SA1 is executed. That is, judgment is first made whether a direction to wirelessly transmit the radio-wave-transmitting command to the mobile station 10 is issued. In the base station 12, for example in the first base station 12A, received the direction to wirelessly transmit the radio-wave-transmitting command to the mobile station 10 issued in SA1, judgment in the step SA2 is affirmed, and the following SA3 is executed. Meanwhile, judgment in the step Sa2 is denied in other base stations 12, for example, the second base stations 12B to the forth base station 12D, and then they stand ready to receive the radio wave from the mobile station 10 without SA3 being performed.

In SA3 corresponding to both the controlling portion 36 and the wireless portion 34 of a base station 12, the radio-wave-transmitting command to the mobile station 10 is wirelessly transmitted. Specifically, the contents of the transmitting command to the mobile station 10 received from the position locating server 14 in SA1 are wirelessly transmitted to the mobile station 10 by the wireless portion 34 switched to a radio-wave-transmitting condition by the controlling portion 36. After performance of transmission, as in other base stations where judgment in SA2 is denied, this base station stands ready to receive the radio wave from the mobile station 10.

In SA4 corresponding to the controlling portion 26 and the wireless portion 24 of the mobile station 10, etc., in response to the radio-wave-transmitting command issued in SA3, a radio wave for position locating is transmitted from the mobile station 10 to each base station 12. The radio wave for position locating is transmitted at a predetermined output for a predetermined period of time, at least for a period of time sufficient for the received power measuring portion 38 of each base station 12 to measure the received radio wave power.

In SA5 corresponding to the received power measuring portion 38 of each base station 12, the radio wave for position locating transmitted from the mobile station 10 is received in SA4, and the received power is measured. The received power is obtained by conversion from the above-mentioned RSSI value, etc., for example, and is a value expressed in logarithm (in decibels). Further, in SA6 corresponding to the wire communication interface 42 of each base station 12, etc., the received power of the radio wave for position locating from the mobile station 10 measured in SA5 is transmitted to the position locating server 14 through the telecommunication cable 18.

In SA7 corresponding to both the reference base station selecting portion 68 and the distance ratio calculating portion 54 of the position locating server 14, based on the received power of the radio wave from the mobile station 10 measured in each base station 12 in SA5, a base station with the highest reception strength, for example the first base station 12A is first selected as the reference base station. Subsequently, a plurality of base station pairs are created, each of which is a combination of the first base station 12A, which is the base station selected as a reference base station, and one of the other base stations, i.e., the second base stations 12B to 12D.

Further, the difference is calculated in the received power of the radio wave from the mobile station 10 between the two base stations that constitute each of the created base station pairs. In the calculation of the difference in the received power, the value of received power Vr (dBm) obtained by conversion from RSSI in SA5 expressed in logarithm (in decibels) is used. Specifically, for example, the difference ΔVr₁₂ between the received power Vr₁ of the first base station 12A which is the reference base station, and the received power Vr₂ of the second base station 12B is calculated. Likewise, the difference ΔVr₁₃ between the received power Vr₁ of the first base station 12A and the received power Vr₃ of the third base station 12C is calculated, and the difference ΔVr₁₄ between the received power Vr₁ of the first base station 12A and the received power Vr₄ of the fourth base station 12D is also calculated.

In SA8 corresponding to the distance ratio calculating portion 54 of the position locating server, based on the difference in the received power of the radio wave from the mobile station 10 between the two base stations constituting each base station pair calculated in SA7, the ratio of distances from the two base stations constituting the base station pair to the mobile station 10 is calculated. That is, the relational expression of Equation (3) is applied to each of the received power differences ΔVr₁₂, ΔVr₁₃, and ΔVr₁₄ calculated in SA7. Accordingly, the ratio (distance ratio) between the distance D₁ from the first base station 12A to the mobile station 10, and the distance D₂ from the second base station 12B to the mobile station 10 (D₁/D₂) is calculated. Likewise, the ratio is calculated between the distance D₁ from the first base station 12A to the mobile station 10 and the distance D₃ from the third base station 12C to the mobile station 10 (D₁/D₃), and the ratio is also calculated between the distance D₁ from the first base station 12A to the mobile station 10 and the distance D₄ from the fourth base station 12D to the mobile station 10 (D₁/D₄) are calculated.

In SA9 corresponding to the solution set calculating portion 56, an equation to express a locus of the mobile station 10 corresponding to the ratio is calculated between distances from the reference base station and the other station to the mobile station 10 calculated in SA8. Such an equation showing the locus is calculated based on the previously obtained positional coordinate of each base station 12 and the value of the distance ratio obtained in SA8, as the equation showing the Apollonius circle realizing the distance ratio. For example, the above Equation (4), Equation (5), and Equation (6) are obtained for the base station pair formed of the first base station 12A and the second base station 12B, the base station pair formed of the first base station 12A and the third base station 12C, and the base station pair formed of the first base station 12A and the fourth base station 12D, respectively.

In SA10 corresponding to the position calculating portion 58, the equations respectively expressing a plurality of loci calculated in SA9 are solved to give a position(s) of the mobile station 10 as the intersection(s) of the plurality of loci.

The following SA11 and SA12 correspond to the position candidate selecting portion 60, etc. First, in SA11, judgment is made whether the intersection of the loci calculated in SA10 is one. When the intersection of the loci is one, judgment in step SA11 is affirmed to give the one intersection as the position of the mobile station 10, followed by ending of the flow chart. Meanwhile, when the intersection of the loci is more than one, judgment in step SA11 is denied, followed by performance of SA12.

In SA12 corresponding to the position candidate selecting portion 60, the region information comparing portion 62, the history information comparing portion 64, etc., one of the plurality of position candidates of the mobile station 10 calculated as intersections of the loci in SA10, is selected as the position of the mobile station 10. This selection is made by comparing information about the position candidates of the mobile station 10 with information about the movable position of the mobile station 10 and/or information about the movement history of the mobile station 10. Specifically, for example, position candidates of the mobile station 10 which are not inside the movable region are excluded, or candidates close to the current position of the mobile station 10 estimated from the movement history of the mobile station are selected. Thus, one of the position candidates of the mobile station 10 is selected as the current position of the mobile station 10.

According to the first embodiment, the following advantages are obtained. First, based on the received power measured by the received power measuring portion 38 (SA5) of the base station 12, the distance ratio calculating portion 54 (SA7, SA8) calculates, as the result of predetermined calculation of the received power in the base station pair, the difference in the received power expressed in logarithm. Based on the calculated difference in the received power expressed in logarithm, the distance ratio is calculated between the distance from one of the base stations constituting the base station pair to the mobile station 10, and the distance from the other of the base stations constituting the base station pair to the mobile station 10. The solution set calculating portion 56 (SA9) calculates, for every base station pair, the set of solutions realizing the distance ratio calculated by the distance ratio calculating portion 54, that is, the locus which is the sequence of points realizing the distance ratio. The position calculating portion 58 (SA10) calculates the intersection of the plurality of loci as the production set of the solution sets calculated by the solution set calculating portion 56. As a result, the existing position of the mobile station 10 is calculated.

Therefore, position locating of the mobile station can be achieved without using the relation between the received power, and the distance between the mobile station and the base station obtained under the specified or fixed transmitted power from the mobile station 10. That is, since position locating is not affected by the transmitted power Pt, the position locating accuracy can be maintained even when the mobile station 10 is low in the remaining power of the battery 28 and decreases in the transmitted power.

The second advantage relates to calculation of a plurality of position candidates of the mobile station 10 by the position calculating portion 58 (SA10). Based on the position information of the mobile station 10 calculated by the position candidate selecting portions 60 (SA 11, 12) using the different method from the position calculating portion 58, the existing position of the mobile station 10 is selected from the candidates for existing position i.e., existing position candidates of the mobile station 10 corresponding to a plurality of solutions calculated by the position calculating portion 58. Therefore, the position locating of the mobile station 10 can be achieved without using the relation between the received power, and the distance between the mobile station 10 and the base station 12, obtained under the fixed transmitted power of the mobile station 10. Accordingly, even upon absence of sufficient number of base stations, position can be located without being affected by the transmitted power from the base station.

A third advantage relates to the position selection of the mobile station 10 by the position candidate selecting portion 60 (SA11) and the region information comparing portion 62 (SA12). Of the positions calculated by the position calculating portion 58 (SA10) as the existing position candidates of the base station 10 based on information (126) about the movement region of the mobile station 10, one is selected as the position of the mobile station 10. Accordingly, the suitable position of the mobile station 10 can be selected.

A fourth advantage relates to the position selection of the mobile station 10 by the position candidate selecting portion 60 (SA11) and the history information comparing portion 62 (SA12). Of the positions P1 and P2 calculated by the position calculating portion 58 (SA10) as the existing position candidates of the base station 10 based on the movement history information of the base station 10, one is selected as the position of the mobile station 10. Therefore, based on the movement history of the mobile station 10, the suitable position is selected for the mobile station 10.

Fifthly, the reference base station selecting portion 68 (SA7) selects the base station 12 with the highest received power measured by the received power measuring portion 38 (SA5) as the reference base station, and the base station pairs are selected as the combination of the reference base station and the other base station. This enables the received power to be measured with the higher value in the distance ratio calculating portion 54 (SA7). That is, it is possible to calculate the result of predetermined calculation of the received power in the base station pair including the base station which can measure the received power more accurately. As a result, the accuracy of the received power difference in each base station pair can be increased, which increases the accuracy of position locating as a whole.

In addition, although the server 14 has the position candidate selecting portion 60 in the first embodiment, the present invention is not limited to such an embodiment. Specifically, the structure may such that, for example, only when the distance ratio calculating portion 54 has succeeded to calculate distance ratios for three or more base station pairs, the position calculating portion 58 calculates the position of the mobile station 10. That is, for example, when the position calculating portion 58 can calculate one solution, the position candidate selecting portion 60 is not necessary. In this way, even without the position candidate selecting portion 60, the mobile station position locating system 8 can provide a predetermined advantage.

### Second Embodiment

Hereinafter, a second embodiment of the present invention will be explained. In the following explanation, explanation of the portions common to the first embodiment is omitted with adding the same numerals thereof.

In the second embodiment, the principal part of the function of the mobile station 10 is expressed by the block diagram shown in FIG. 2, as in the first embodiment. Among the components, the wireless portion 24 has the same function as in the first embodiment. The controlling portion 26 has the following functions, in addition to the function of controlling the operation of the mobile station 10 in the first embodiment. Specifically, the controlling portion 26 has a function of adding an error detecting code added for detecting errors in a parity check bit and the like, to the data included in the radio wave transmitted from the mobile station 10 to each base station 12. The error detecting code is calculated from the transmitted data according to the predetermined calculation method, to be transmitted to each base station together with the transmitted data.

Further, the principal part of the function of the base station 12 is expressed by the block diagram shown in FIG. 3, as in the first embodiment. The difference from the first embodiment is usage of an error rate calculating portion 40, which was not used in the first embodiment.

The error rate calculating portion 40 calculates the error rate (BER: Bit Error Rate), which is an incidence of a communication error in the communication between the mobile station 10 and the base station 12, based on received data and error detecting codes included in the radio wave from the mobile station 10 received by the wireless portion 34 of the base station 12. Specifically, the error rate calculating portion 40 calculates error detecting codes from the received data according to, for example, the same calculation method as that according to which the controlling portion of the mobile station 10 calculates the error detecting codes. The error detecting codes calculated in the error rate calculating portion 40 are compared with the received error detecting codes calculated in the mobile station 10.

Accordingly, the errors in the received data can be detected, based on which the error rate can be calculated. As a result, the base station 12 with the smaller error rate is expected to suffer from a smaller number of errors in communication with the mobile station 10, which means that the communication between the mobile station 10 and such a base station 12 can be considered reliable.

These transmitted data and error detecting codes for the error rate calculation may be included in the radio wave transmitted for position locating, for example. Otherwise, the radio wave containing the transmitted data and the error detecting codes for the error rate calculation may be transmitted separately from the radio wave for position locating.

The function outline of the position locating server is expressed by FIG. 4 explained in the first embodiment, but the reference base station selection operation by the reference base station selecting portion 68 is different from that of the first embodiment. Specifically, when creating the base station pairs in the distance ratio calculating portion 54, the reference base station selecting portion 68 selects the reference base station to be contained in all the base station pairs. At this time, considering the error rate calculated in the error rate calculating portion 40 of each of the base stations, the reference base station selecting portion 68 selects the base station with the lowest error rate as the reference base station. This is because a base station with the lowest error rate is considered to be a base station with highest reliability in communication with the mobile station 10, and is expected to be obtained the accurate received radio wave power.

The outline of the control operation of the mobile station position locating system of the present embodiment is shown in FIG. 10 as in the first embodiment. The control operations in SA5, SA6, and SA7, which are steps corresponding to the differences from the first embodiment, are different from that of the first embodiment.

Specifically, in SA53 corresponding to both the received power measuring portion 38 and the error rate calculating portion 40 of each base station 12, the radio wave for position locating transmitted from the mobile station 10 is received in SA4, and the received power is measured. Further, based on the data and error detecting codes transmitted from the mobile station 10, the error rate is calculated, which is the incidence of communication errors in the data communication from the mobile station 10 to each base station 12. Further, in SA6 corresponding to the wire communication interface 42 of each base station 12, etc., the received power of the radio wave for position locating from the mobile station 10 and the error rate, measured in SA5, are transmitted to the position locating server 14 through the telecommunication cable 18.

In SA7 corresponding to both the reference base station selecting portion 68 and distance ratio calculating portion 54 of the position locating server 14, based on the error rate in the communication from the mobile station 10 to each base station 12 calculated in each base station 12 in SA5, the base station with the lowest error rate, for example the first base station 12A, is first selected as the reference base station. Subsequently, a plurality of base station pairs are created, each of which is the combination of the first base station 12A, which is the base station selected as the reference base station, and one of the other base stations, i.e., the second base stations 12B to 12D. Further, for each of the created base station pairs, the difference is calculated in the received power of the radio wave from the mobile station 10 between the two base stations constituting each base station pair. In the calculation of the difference in received power, the value of received power Vr (dBm) is used, which is expressed in logarithm (in decibels) obtained by conversion from RSSI measured in the above SA5.

Specifically, for example, the difference ΔVr₁₂ is calculated between the received power Vr₁ of the first base station 12A and the received power Vr₂ of the second base station 12B. Also calculated are, the difference ΔVr₁₃ between the received power Vr₁ of the first base station 12A and the received power Vr₃ of the third base station 12C, and the difference ΔVr₁₄ between the received power Vr₁ of the first base station 12A and the received power Vr₄ of the third base station 12D.

The control operations in other steps are the same as in FIG. 10, and explanations thereof are therefore omitted.

According to the above the second embodiment, a radio wave containing data having error detecting codes added is transmitted from the mobile station 10, and the error rate calculating portion 40 (SA5) calculates the error rate, which is the error occurring degree at the time when each base station 12 receives the radio wave from the mobile station 10. The reference base station selecting portion 68 (SA7) selects the base station 12 with the smallest error rate calculated by the error rate calculating portion 40 as the reference base station. The base station pairs are each selected as the combination of the reference base station and one of the other base stations. Accordingly, the position calculating portion 58 (SA10) can calculate the result of predetermined calculation of the received power in the base station pair including the base station with the small error rate, i.e., which does not suffer from interference from others and satisfactorily receive the radio wave from the mobile station. As a result, the accuracy of the received power difference in each base station pair can be increased, which increases the accuracy of position locating as a whole.

The embodiments of the present invention have been described in detail based on the drawings; however, the present invention is also applicable in other embodiments.

For example, in the embodiments mentioned above, the reference base station selecting portion 68 selects, as the reference base station, the base station 12 with the strongest received power of the radio wave from the mobile station 10 or the base station 12 with the smallest error rate in communication with the mobile station 10 calculated by the error rate calculating portion 40. However, the present invention is not limited thereto. For example, the reference base station may be the base station with the highest resolution in the received power measuring portion 38. This enables calculation of the result of predetermined calculation of the received power in the two base stations of the base station pair configured to include the base station 12 where the resolution is preset at the high level, i.e., designed for the high sensitivity, to measure the received power accurately.

On the other hand, the selection of the reference base station is not an indispensable requirement for implementation of the present invention. That is, when there are four or more base stations which receive the radio wave from the mobile station 10, the loci are calculated corresponding to three or more base station pairs arbitrarily selected from all the possible base station pairs. The position of the mobile station 10 can be calculated from such calculation, which also provide a certain degree of advantage.

In the above second embodiment, the controlling portion 26 of the mobile station 10 adds the error detecting code to the data to be transmitted, and the error rate calculating portion 40 of the base station 12 calculates the error rate BER in the wireless communication from the mobile station 10 to the base station 12 based on such error detecting codes. However, the present invention is not limited to such an embodiment. Another example may be as follows. Known bit pattern data and the like are previously given to in the mobile station 10 and the base stations 12, and the mobile station 10 transmits the known bit pattern data and the like to the base station 12. Data extracted from the radio wave received by the base station 12 is compared with the previously given data, to thereby calculate the error rate.

Further, as explained in the above embodiments, when the position of the mobile station 10 moving on the plane is calculated using four base stations 12, if these four base stations 12 are arranged to constitute square vertexes, the position calculating portion 58 will calculate a plurality of position candidates of the mobile station 10. To prevent this, the base stations 12 used for calculation of the position of the mobile station 10 may be previously arranged to be calculated by the position calculating portion 58 is not more than one. Specifically, for example, they may be arranged not in a relation to constitute square vertexes. Further, when five or more base stations 12 exist, the base stations 12 used for calculation of the position of the mobile station 10 may be selected so that the position of the mobile station 10 calculated by the position calculating portion 58 is not more than one.

Further, in the second embodiment, the solution set calculating portion 56 calculates solution sets, each of which is the set of solutions satisfying the distance ratio for each base station pair calculated by the distance ratio calculating portion 54, for every base station pair as the circle. However, the present invention is not limited to such an embodiment. For example, the solution set calculating portion 56 may calculate the solution set for every base station pair as a circular probability density distribution where the distribution center is the circle satisfying the distance ratio. The position calculating portion 58 may superimpose the plurality of calculated probability density distributions to define, for example, a place where the product of existence probability for a base station pair is high, as the solution, i.e., the position of the mobile station 10.

In addition, although not illustrated in every detail, various modifications may be made to the implementation of without deviating from the spirit of the present invention.

What is claimed is:

1. A mobile station position locating system in which a plurality of base stations receive a radio wave transmitted from a mobile station, and which estimates a position of the mobile station based on a received power of the radio wave received by each base station and a position of the base station,
wherein the mobile station includes a transmitting portion that transmits the radio wave having a predetermined frequency, and
the base stations each includes a receiving portion that receives the radio wave transmitted by the mobile station, and a received power measuring portion that measures a received power of the radio wave received by the receiving portion,
the mobile station position locating system further comprising:
a distance ratio calculating portion that calculates, based on a result of predetermined calculation of the received power measured by the received power measuring portion of each of the base stations constituting a base station pair which is a pair of the base stations, a distance ratio for every base station pair between the distance from one of the base stations constituting the base station pair to the mobile station and the distance from the other of the base stations constituting the base station pair to the mobile station,
a solution set calculating portion that calculates for every base station pair a set of solutions realizing the distance ratios calculated by the distance ratio calculating portion, and
a position calculating portion that determines a production set of a plurality of solution sets calculated by the solution set calculating portion to calculate, a solution belonging to the production set of the solution sets, as a mobile station existing position.

2. A mobile station position locating system according to claim 1, further comprising, when the position calculating portion calculates a plurality of solutions belonging to the production set of the solution sets, a position candidate selecting portion that selects the mobile station existing position, from candidates for the mobile station existing position corresponding to the plurality of solutions calculated by the position calculating portion, based on a position information of the mobile station calculated by a method different from a method used in the position calculating portion.

3. A mobile station position locating system according to claim 2, wherein the position candidate selecting portion selects, as the position of the mobile station, one of the positions calculated by the position calculating portion as the candidates for the mobile station existing position based on the information about a movable region of the mobile station.

4. A mobile station position locating system according to claim 2, wherein the position candidate selecting portion selects, as the position of the mobile station, one of the positions calculated by the position calculating portion as the candidates for the mobile station existing position based on an information about a movement history of the mobile station.

5. A mobile station position locating system according to claim 1, wherein the position calculating portion selects, as a reference base station, a base station with the highest received power measured by the received power measuring portion, to select the base station pairs as a combination of the reference base station and other base station.

6. A mobile station position locating system according to claim 1, further comprising an error rate calculating portion calculating an error rate which is an error occurring degree in the radio wave received by each of the base stations transmitted from the mobile station,
wherein the position calculating portion selects, as the reference base station, the base station with the smallest error rate calculated by the error rate calculating portion, to select the base station pair as a combination of the reference base station and the other base station.

7. A mobile station position locating system according to claim 1, wherein the position calculating portion selects, as the reference base station, the base station with the highest resolution in the received power measuring portion, to select the base station pairs as a combination of the reference base station and the other base station.
